(19) United States
(12) Patent Application Publication
(10) Pub. No.: US 2006/0290100 A1
(43) Pub. Date: Dec. 28, 2006

(54) Vehicle hitch aligning system

(76) Inventor: Steve Miller, Searcy, AR (US)

Correspondence Address: LITMAN LAW OFFICES, LTD, PO BOX 15035, CRYSTAL CITY STATION, ARLINGTON, VA, 22215, US

(21) Appl. No.: 11/445,296

(22) Filed: Jun. 2, 2006

Related U.S. Application Data
(60) Provisional application No. 60/693,056, filed on Jun. 23, 2005.

(51) Int. Cl. B60D 1/36

(52) U.S. Cl. 280/477

(57) ABSTRACT

The vehicle hitch aligning system includes a set of alignment images on decals applied to a towing vehicle's rear view mirror, the center region of the rear window of the towing vehicle, an exterior surface of the towing vehicle's rear that is visible from the driver's side of the towing vehicle's interior (when appropriate), and on a front surface of the trailer. Included is an alignment rod attachable to the trailer for assisting alignment. Alternatively, the alignment images are applied to the towing vehicle and the trailer by being impressed, imprinted, embossed, projected on, embedded in, illuminated, or otherwise applied to the indicated surfaces. The system may include a stop plate attached to the towing vehicle's hitch assembly in order to stop the vehicle with the hitch and trailer tongue coupler in vertical alignment, while the images are used to align the towing vehicle with the trailer axially (laterally).

### CROSS-REFERENCE TO RELATED APPLICATION

This application claims the benefit of U.S. Provisional Patent Application Ser. No. 60/693,056, filed Jun. 23, 2005.

### FIELD OF THE INVENTION

The present invention relates to vehicle hitch aligning systems, and more particularly to a vehicle hitch aligning system that may be used to align a hitch with a trailer tongue without assistance and without the need for getting out of a towing vehicle to check for positioning and alignment of the hitch and trailer tongue.

### DESCRIPTION OF THE RELATED ART

Towing vehicles and trailers are often coupled with a ball and socket-type coupler. The ball is usually mounted at the rear or in the bed of the towing vehicle and the coupler is mounted on a tongue extending from the front of the trailer. Precise alignment of the ball and coupler socket is required to allow the ball and socket to be coupled. Aligning these components without assistance from a person outside the vehicles is very often frustrating and difficult. When the ball and socket are blocked from the driver's view, the driver often has to get out of the towing vehicle a number of times to check the relative position of the hitching components, or else run the risk of colliding the two vehicles with resulting damage, such as dented bumpers, dented license plates, dented tailgates, and the like. Closing distance, i.e., vertical alignment and left-right or axial alignment, of the two vehicles can be equally difficult to judge.

United Kingdom Patent No. 2,328,416, published Feb. 24, 1999, describes hitch alignment by using an outboard convex mirror mounted on the towing vehicle. However there remains a need for a vehicle hitch aligning system to provide both visual and mechanical aid in aligning a tow hitch and trailer coupler that provides both vertical and axial alignment components in order to assist the driver in maneuvering a towing vehicle during a hitching operation without assistance from another person. Thus, a vehicle hitch aligning system solving the aforementioned problems is desired.

### SUMMARY OF THE INVENTION

The vehicle hitch aligning system comprises a set of alignment images on decals applied to a towing vehicle's rear view mirror, the center region of the rear window of the towing vehicle, an exterior surface of the towing vehicle's rear that is visible from the driver's side of the towing vehicle's interior (when appropriate), such as a tailgate, a camper window, an automobile trunk lid, and the like, and on a front surface of the trailer. Included is an alignment rod attachable to the trailer for assisting alignment. Alternatively, the alignment images are applied to the towing vehicle and the trailer by being impressed, imprinted, embossed, projected on, embedded in, illuminated, or otherwise applied to the indicated surfaces. The system may include a stop plate attached to the towing vehicle's hitch assembly in order to stop the vehicle with the hitch and trailer tongue coupler in vertical alignment, while the images, (and alignment rod when necessary), are used to align the towing vehicle with the trailer axially (laterally).

These and other features of the present invention will become readily apparent upon further review of the following specification and drawings.

### BRIEF DESCRIPTION OF THE DRAWINGS

FIG. 1A is an environmental perspective view of the vehicle hitch aligning system, depicting system operation according to the present invention.

FIG. 1B is an environmental perspective view showing the stop plate portion of the vehicle hitch aligning system of the present invention with the trailer tongue aligned with the ball hitch.

FIG. 1C is an environmental perspective view showing the stop plate portion of the vehicle hitch aligning system of the present invention with the ball and trailer tongue coupler connected.

FIG. 1D is a perspective view of a rear view mirror with the alignment images and alignment rod of the vehicle hitch aligning system of the present invention applied to and reflected in the rear view mirror.

FIG. 2 is an environmental perspective view showing a trailer tongue equipped with an alignment rod of the vehicle hitch aligning system according to the present invention.

FIG. 3A is an environmental perspective view of a tow hitch ball mount equipped with a first embodiment of a removable stop plate of the vehicle hitch aligning system according to the present invention.

FIG. 3B is a perspective view of the stop plate of FIG. 3A.

FIG. 4 is an environmental perspective view of a second embodiment of a removable stop plate of the vehicle hitch aligning system according to the present invention.

FIG. 5 is an environmental perspective view of a drop hitch ball mount equipped with a permanent mount stop plate of the vehicle hitch aligning system according to the present invention.

FIG. 6 is an environmental perspective view of a riser ball mount equipped with a permanent mount stop plate of the vehicle hitch aligning system according to the present invention.

FIG. 7A is an environmental perspective view of a removable stop plate with a shim attached.

FIG. 7B is an environmental perspective view of a permanent stop plate with a shim attached.

Similar reference characters denote corresponding features consistently throughout the attached drawings.

### DETAILED DESCRIPTION OF THE PREFERRED EMBODIMENTS

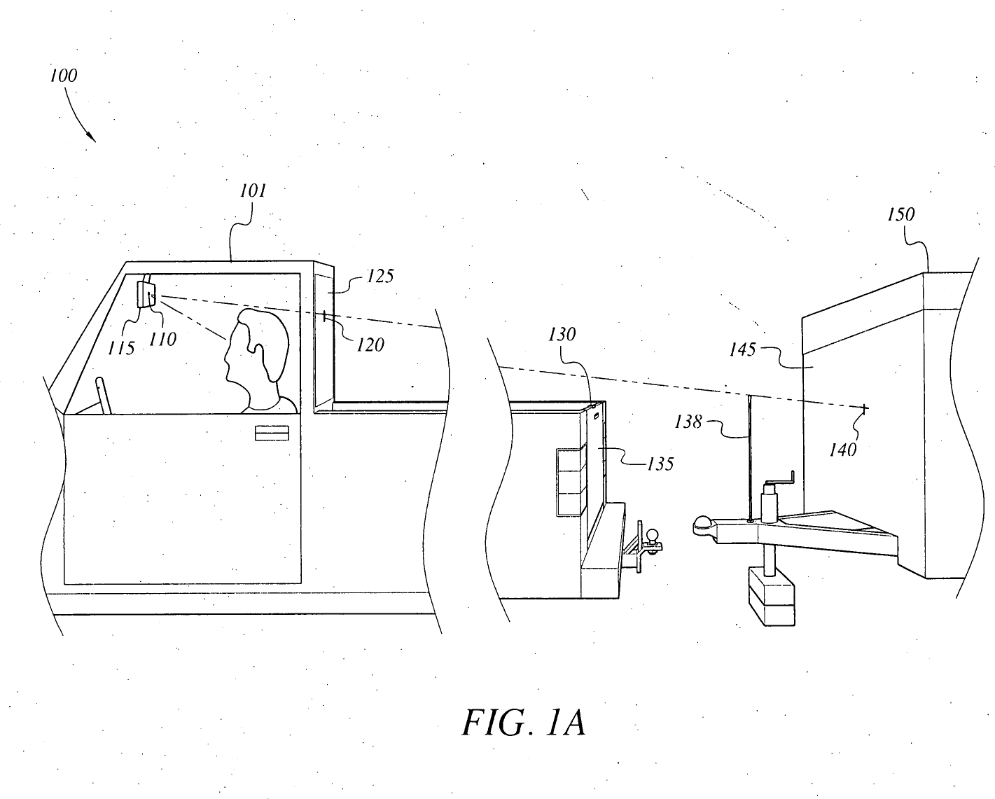

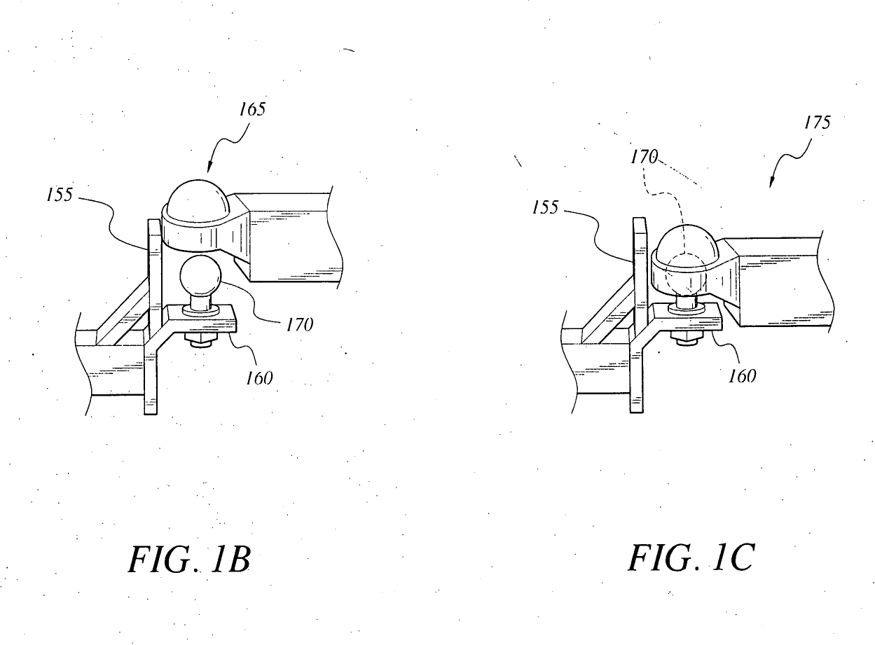

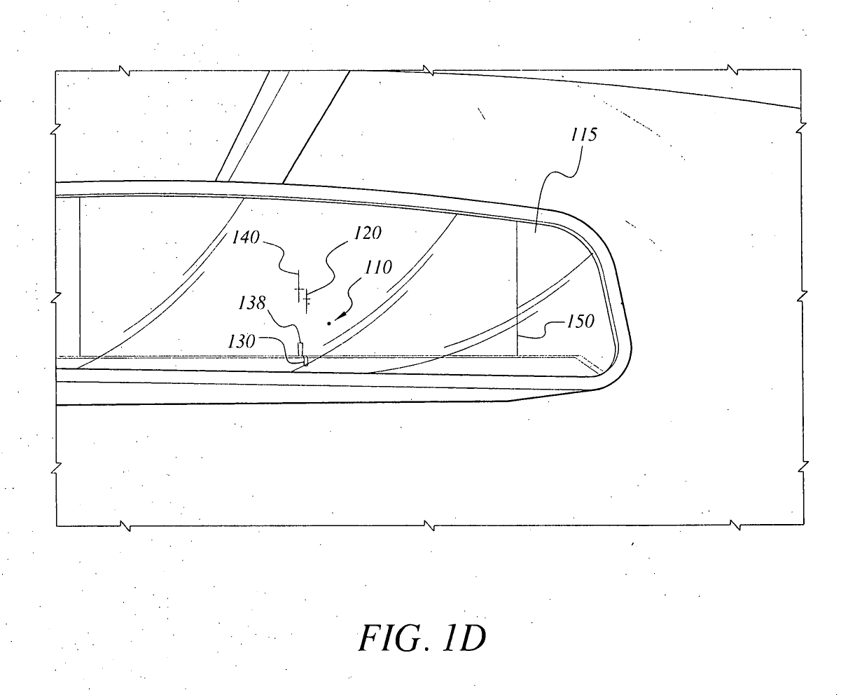

The present invention is a vehicle hitch aligning system, which, in one particular embodiment, may comprise a first decal bearing a clearly visible dot, or other similar image, which functions as a parallax alignment image 110 that is applied to a towing vehicle's rear view mirror 115, as shown in FIG. 1A. Using the parallax alignment image 110, a driver may position the driver's eye gaze into the rear view mirror 115 for alignment with line-of-sight crosshairs, or other suitable alignment images, mounted to the vehicle rearward of the rear view mirror 115. The parallax alignment image 110 may be made clearly visible by being formed of a bright color, such as red, and/or making or coating it so that it is reflective, e.g., a reflective label.

A second decal bearing a first crosshair image 120, or other suitable alignment image, of small dimension is applied to the rear window of the towing vehicle, preferably in the center region. Alternatively, instead of decals, the parallax alignment image 110 and the first crosshair 120, or other suitable rear window image, may be applied to the towing vehicle by being impressed, imprinted, embossed, projected on, embedded in, illuminated, or otherwise applied to the towing vehicle.

A sight 130 may be formed by at least one narrow adhesive strip placed on an exterior surface of the towing vehicle's rear, e.g., adjacent the top edge of the tailgate 135 of a pickup truck, as shown in FIG. 1A. The sight 130 is aligned vertically with the hitch receiver or drawbar and is visible from the driver's side of the towing vehicle's interior. The visibility of the sight 130 is enhanced by forming the adhesive strip from bright-colored tape, such as red tape, making or coating the adhesive strip from reflective material, including an alignment stripe centered on a background of a different color, etc. Alternatively, the sight 130 may be formed by impressing, imprinting, embossing, projecting on, embedding in, illuminating, or otherwise applying a sight image on the truck. When it is impracticable to place the sight 130 on an exterior surface of the towing vehicle, e.g., when the vehicle does not have an exterior rear section that is visible to the driver, for example, when the truck has a camper top, the sight 130 may be placed on the rear window instead of, or in addition to, the crosshair image 120.

Another decal bearing a second crosshair or other suitable alignment image 140 of larger dimension than crosshair image 120 is applied to a front surface 145 of the trailer 150 in alignment with the trailer tongue, and particularly the coupler attached to the trailer tongue. Alternatively, image 140 may be applied to the trailer tongue on trailers such as a 5th wheel or gooseneck where the tongue is visible from a driver's perspective. Second alignment image 140 may be made more visible by making or coating it with reflective material. Alternatively, image 140 may be formed by impressing, imprinting, embossing, projecting on, embedding in, illuminating, or otherwise forming the image on the front surface 145 of the trailer 150.

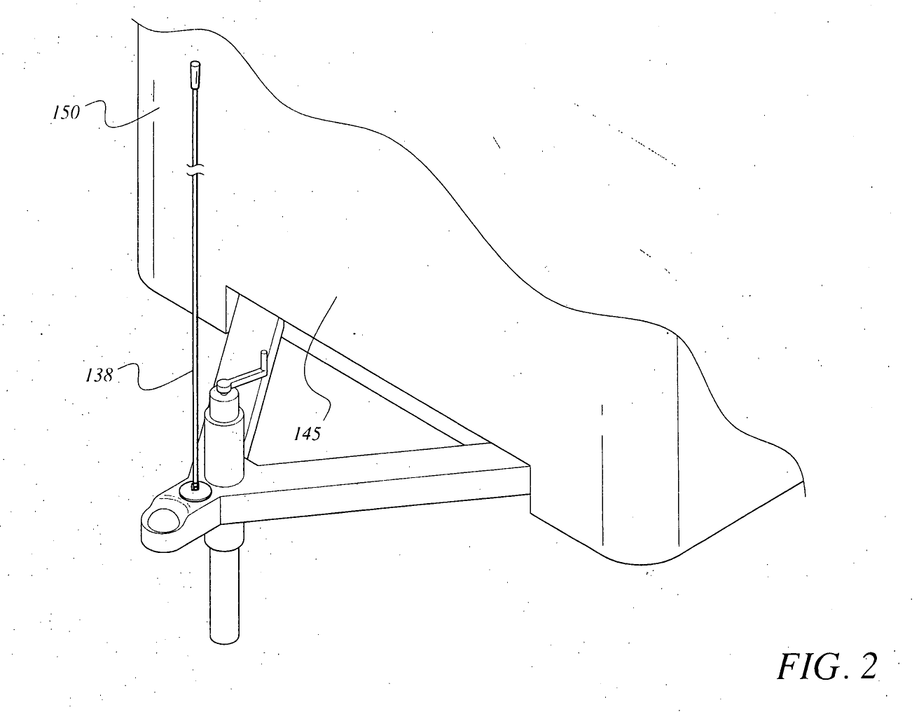

In the event that the front surface 145 of the trailer 150 is not visible from the towing vehicle driver's perspective, an alignment rod 138, shown more clearly in FIG. 2, can be attached -to the tongue of the trailer 150 to provide line-of-sight visibility for alignment of the hitch with the trailer tongue coupler. Preferably, the alignment rod 138 should be made highly visible by the use of reflective material, illumination, luminescence, or other means in order to be clearly visible in a wide variety of lighting conditions, including nighttime.

The alignment rod 138 may be of fixed length or telescoping. The rod 138 may be retractable, so that when not in use it may rest along a surface of trailer 150. The rod 138 may be attached to the trailer 150 by bolts, screws, or other fasteners, by welding, or by other suitable fastening means. Alternatively, the rod 138 may be easily detachable from the trailer 150 by being magnetically attached, attached by clamps, attached by straps, etc.

Referring to FIG. 1D, it is shown how the parallax image 110, the sight 130, the first crosshair image 120, the alignment rod, and the second crosshair image 140 might appear in the rear view mirror 115 as the vehicles approach and before alignment of the hitching receiver with the coupler on the trailer tongue. At least image 120, or sight 130 attached to the towing vehicle and image 140 or alignment rod 138 of the trailer are preferably used by a driver to achieve proper hitch alignment according to the present invention.

As shown in FIGS. 1B and 1C, a stop plate 155 may be attached to the towing vehicle's hitch assembly 160 in order to provide a stop when the towing vehicle backs up close enough to the trailer tongue with the coupler 165 aligned above the ball 170 of the hitch assembly 160. The stop plate 155 is an elongated plate that is attached to the drawbar, ball mount, or hitch receiver behind the ball 170 and extends high enough above the ball 170 that when the towing vehicle backs up just far enough to position the ball 170 beneath the coupler 165 in alignment therewith, the leading edge of the coupler 165 makes contact with the stop plate 155, which can be felt and/or heard by the driver.

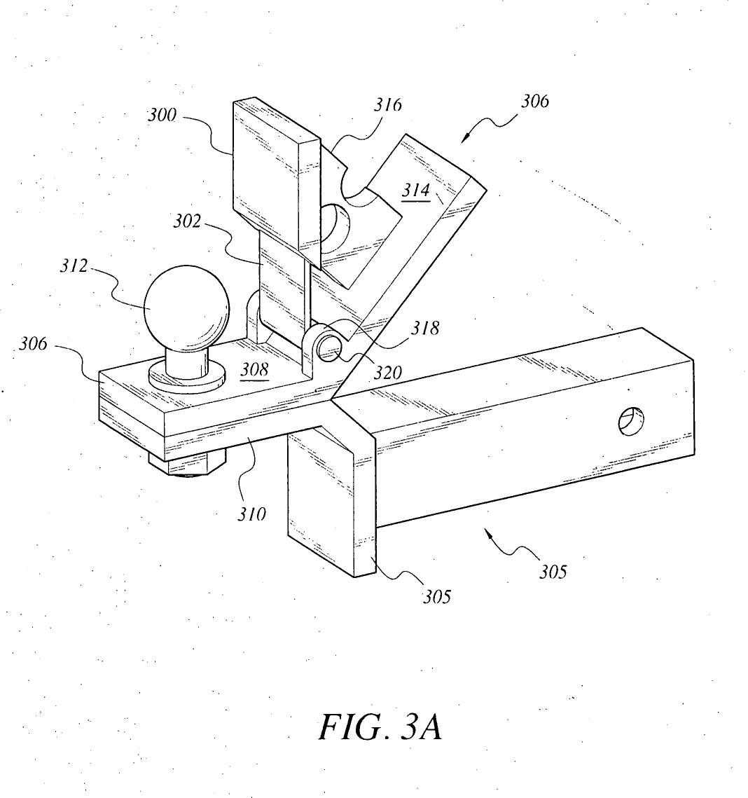

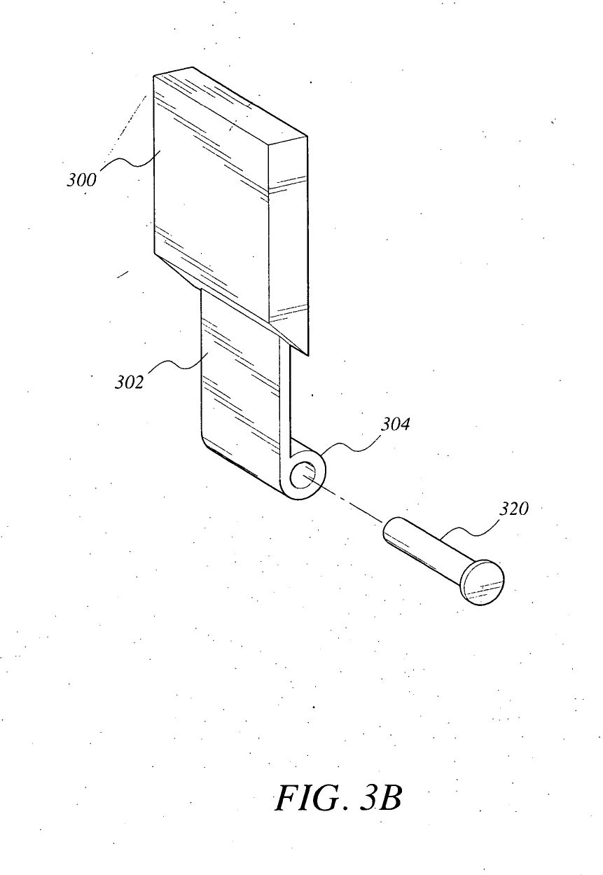

At least two types of stop plates are made available for attachment to the towing vehicle. A first type of stop plate is a removable stop plate 300, shown in FIGS. 3A and 3B, which is adaptable to the various existing ball mounts currently in use. The removable stop plate 300 includes a mounting tang 302 depending from the stop plate 300. The tang 302 includes a hollow, cylindrical retainer 304 extending across the free end of the tang 302. The stop plate 300 is mounted to the ball mount 305 by a stop plate support 306 having a first plate 308 attachable to the ball mount platform 310 by extending the shank of the ball 312 through an aperture formed in the first plate, and having a second plate 314 extending at an oblique angle to the first plate 308 that may be adapted to brace against a bumper of the towing vehicle. The first plate 308 and second plate 314 may be welded or otherwise joined together, or may be cast in a unibody construction to form left and right mounting lugs 318. Bolt or pin 320 is inserted through mounting lugs 318 and cylindrical retainer 304 to pivotally attach stop plate 300 to the stop plate support 306. A gusset 316 extends forward from second plate 314 and bears against stop plate 300 when the coupler is properly positioned above ball 312.

Due to the fact that trailer hitch couplers are available in several different sizes with different size lips on them, the present invention provides for stop plate adjustment means making the stop plate adjustable to accommodate the coupler variations. Thus, gusset 316 may be fabricated having a predetermined length to customize travel of stop plate 300 adaptable to a specific-trailer hitch coupler configuration and dimension.

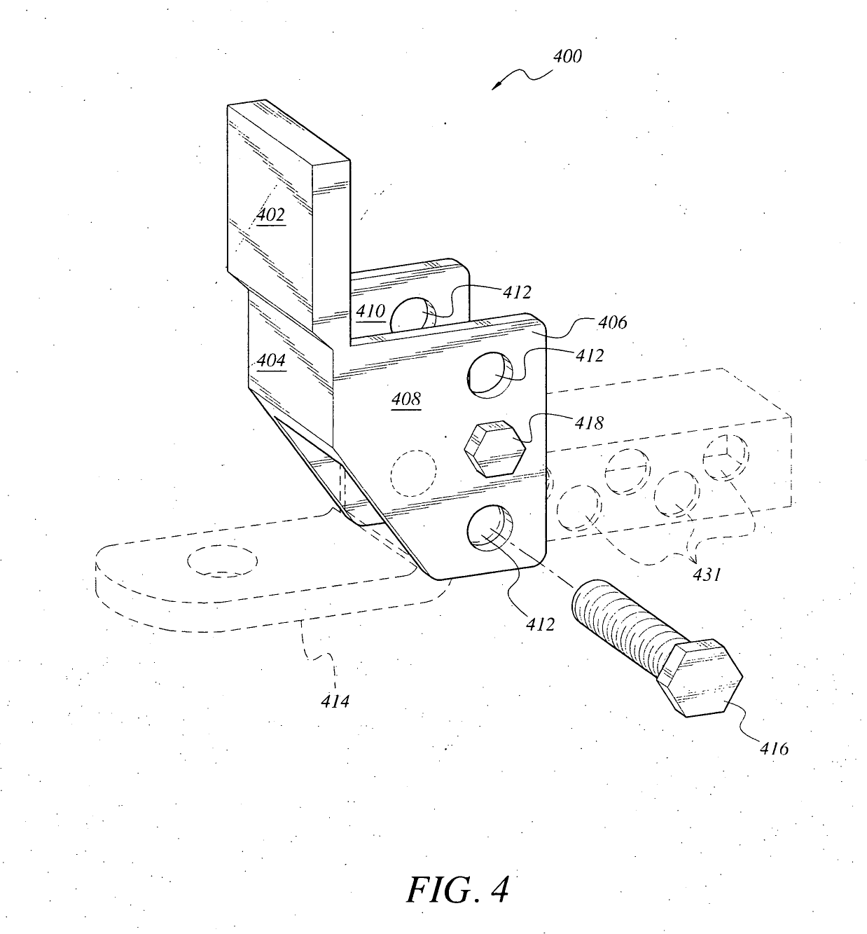

FIG. 4 shows an alternative embodiment of a removable stop plate 400. Removable stop plate 400 comprises a thick planar plate 402 extending above the crosspiece or bight 404 of U-shaped mount 406. The side plates 408 and 410 of the U-shaped mount 406 have a plurality of aligned holes 412 defined therein for pivotally attaching stop plate 400 to the shank of a ball mount 414 by a pin or bolt 416, and for receiving a stop bolt 418 that bears against the top of the shank of ball mount 414 when the coupler pushes plate 402 to a substantially vertical position with the coupler aligned above the ball. Bight 404 is a truncated rectangular plate and side plates 408 and 410 are also substantially rectangular plates, but with the lower front portion of the plates being beveled rearward from the lower edge of the bight 404 so that stop plate 400 pivots forward above the ball mount platform until plate 402 bears against the hitch ball when the trailer tongue is uncoupled from the hitch ball.

Due to the fact that trailer hitch couplers are available in several different sizes with different size lips on them, the present invention provides for stop plate adjustment means making the stop plate adjustable to accommodate the coupler variations. Thus, auxiliary shank holes 431 are provided to allow for custom mounting positions of stop plate 400 to adjust the stop plate distance from the hitch ball in order to accommodate a particular trailer hitch coupler configuration and dimension.

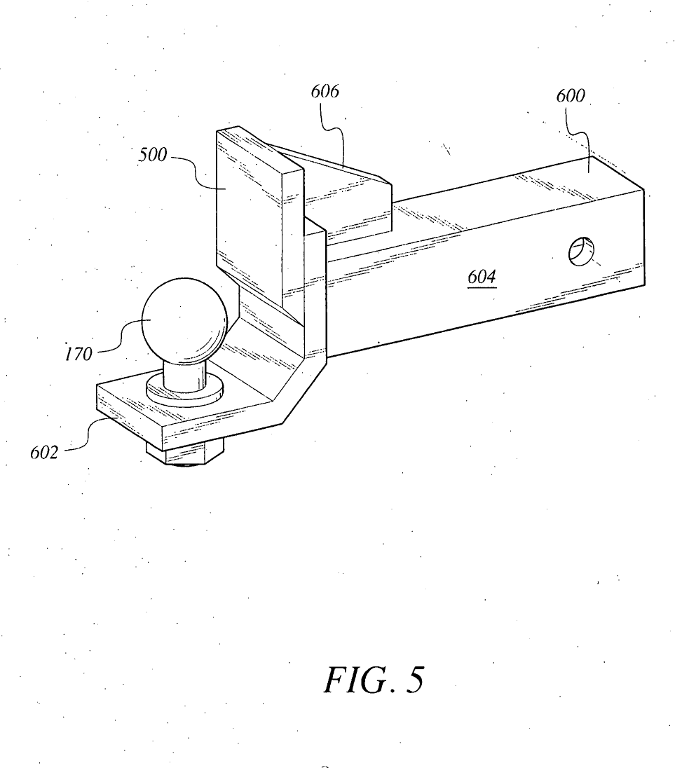

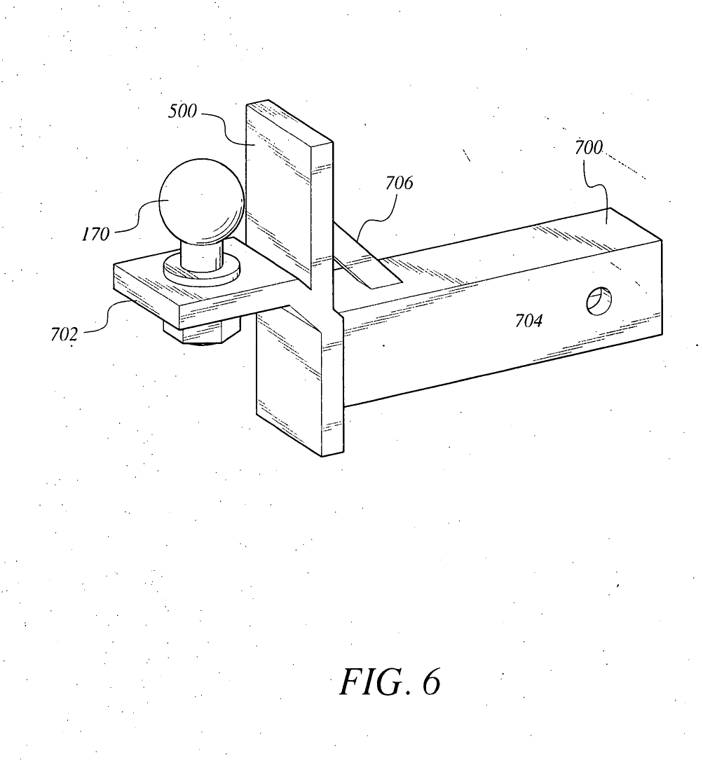

Instead of a removable stop plate, the vehicle hitch aligning system may have a permanent stop plate, as shown in FIGS. 5 and 6, permanently mounted on a customized ball mount. The customized ball mount may be either 45° design or 90° design. In addition, the customized ball mount may be of any angle that allows a permanent mounting and bracing of the permanent stop plate 500.

The permanent stop plate 500, as shown in FIGS. 5 and 6, is welded and braced to a ball mount. As shown in FIG. 5, the permanent stop plate. 500 may be mounted on a drop hitch ball mount 600 having a ball mounting platform 602 extending in a plane below the level of the tube or shank 604 that slides into the hitch receiver. Alternatively, as shown in FIG. 6, the permanent stop plate 500 may be mounted on a riser ball. mount 700 having a ball mounting platform 702 extending in a plane above the level of the tube or shank 704 that slides into the hitch receiver. In either case, the stop plate 500 is welded to the ball mount assembly so that the stop plate 500 extends above the height of the ball 170. The stop plate 500 may be supported by a gusset, strut, or other bracing structure 606 or 706.

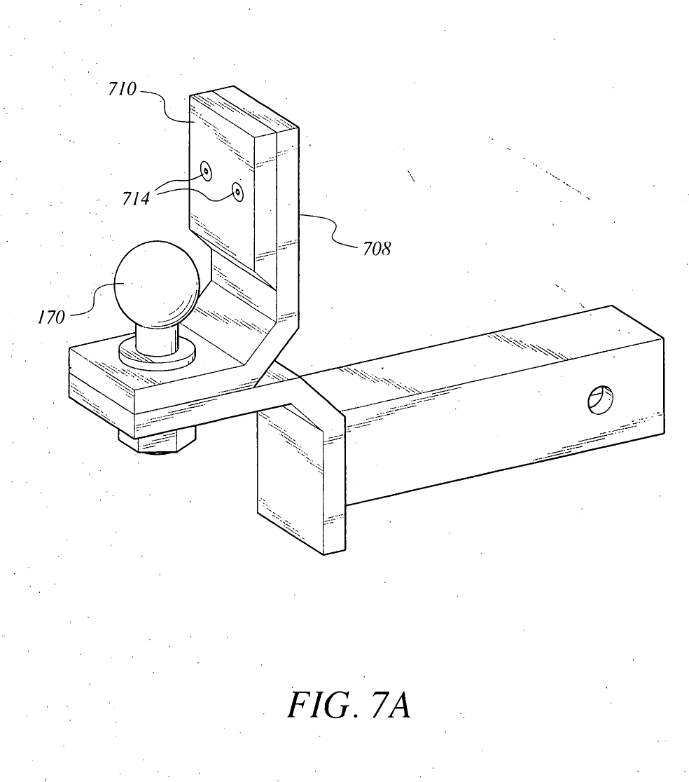

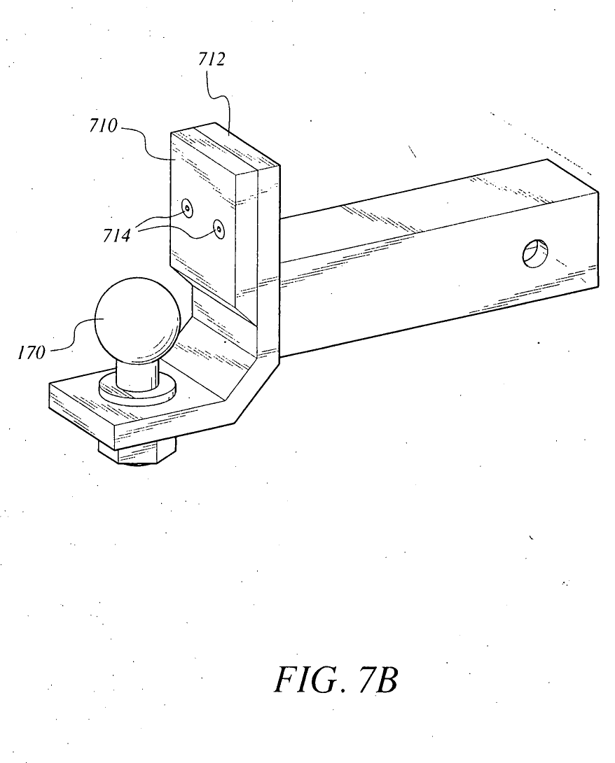

Due to the fact that trailer hitch couplers are available in several different sizes with different size lips on them, the present invention provides for stop plate adjustment means making the stop plate:adjustable to accommodate the coupler variations. Thus, as shown in FIG. 7A, removable stop plate 708 has been equipped with a means for adjusting the position of the stop plate for use with a particular trailer hitch coupler configuration and dimension. The embodiment of FIG. 7A provides for adjustment of the stop plate distance from the hitch ball by providing for the attachment of a shim 710 to the stop plate 708 in order to fill any space between the stop plate 708 and the lip of the trailer coupler that might otherwise prevent proper alignment of the coupler with the ball. The shim 710 may comprise one or more additional plates of custom designed thickness that are attached to the stop plate 708 by fasteners 714, brackets, clamps, or any other means known in the art for attaching a first plate to a second plate. Similarly, as shown in FIG. 7B, permanent stop plate 712 may be equipped with a means for adjusting the position of the stop plate, such as a shim 710 of any desired thickness attached to the stop plate 712 by fasteners 714, or by any other fastening means known in the art for attaching a first plate to a second plate, for use with a particular trailer hitch coupler configuration and dimension.

Preparation and installation of the system components of the present invention are straightforward. The rear window image or crosshair 120 is positioned in the center region of the towing vehicle's rear window 125; the sight 130 is positioned on the tailgate 135 of the towing vehicle in alignment with the hitch receiver; the front surface image 140 is positioned on the front surface of the trailer 145 in alignment with the coupler mounted on the trailer tongue; alternatively, the front surface image 140 may be mounted on the trailer tongue for trailers with a 5^{th} wheel or gooseneck configuration; a line of sight rod 138 is installed on the trailer if the trailer is too low for visualization of the front surface image 140 through the rear view mirror, or to enhance visibility of trailer; optionally, a parallax alignment image 110 is positioned on the rear view mirror 115 of the towing vehicle 101; a removable stop plate 300 or 400 is installed on the receiver hitch, e.g., ball mount 160, or alternatively a custom ball mount with permanent stop plate 500 is installed on the towing vehicle 101. The imaging components align the receiver hitch with the coupler axially by visual alignment of the imaging components, while the stop plate aligns the coupler above the hitch ball vertically by applying resistance to further backing of the towing vehicle.

It is to be understood that the present invention is not limited to the embodiment described above, but encompasses any and all embodiments within the scope of the following claims.

I claim:

1. A vehicle hitch aligning system, comprising:
a first alignment image mounted rearward of a rear view mirror of a towing vehicle in alignment with a hitch receiver mounted on the towing vehicle;
an alignment device adapted for mounting on a trailer in alignment with a trailer hitch coupler mounted on the trailer; and
a stop plate adapted for mounting to the hitch receiver;
whereby the hitch receiver is axially aligned with the coupler by backing the towing vehicle up to the trailer with the first alignment image aligned with the alignment device and the coupler is aligned vertically above the hitch receiver by backing the towing vehicle up to the trailer until the coupler contacts the stop plate.

2. The vehicle hitch aligning system according to claim 1, wherein the first alignment image comprises an image disposed on a rear window of the towing vehicle.

3. The vehicle hitch aligning system according to claim 1, wherein the first alignment image comprises an image disposed in a center region of a rear window of the towing vehicle.

4. The vehicle hitch aligning system according to claim 1, wherein the first alignment image comprises a crosshair image.

5. The vehicle hitch aligning system according to claim 1, wherein the first alignment image is of small dimension.

6. The vehicle hitch aligning system according to claim 1, wherein the first alignment image comprises a decal.

7. The vehicle hitch aligning system according to claim 1, wherein said alignment device comprises a second alignment image, the second alignment image being of larger dimension than said first alignment image.

8. The vehicle hitch aligning system according to claim 7, wherein said second alignment image comprises a crosshair image.

9. The vehicle hitch aligning system according to claim 7, wherein said second alignment image comprises a decal.

10. The vehicle hitch aligning system according to claim 1, wherein said alignment device comprises an alignment rod adapted for attachment to a tongue of the trailer.

11. The vehicle hitch aligning system according to claim 1, further comprising a parallax alignment image adapted for being applied to the towing vehicle's rear view mirror.

12. The vehicle hitch aligning system according to claim 1, further comprising a sight adapted for being disposed on an exterior surface of the towing vehicle's rear, the sight being visible from the driver's side of the towing vehicle's interior, the sight further being in lateral alignment with the hitch receiver.

13. The vehicle hitch aligning system according to claim 1, wherein said the first alignment image and said alignment device are visibly bright and reflective.

14. The vehicle hitch aligning system according to claim 1, wherein said stop plate is elongated, adapted for being disposed behind a ball of the hitch receiver, has a height configured for being above the ball to facilitate contact of a coupler of a trailer with the stop plate of an aligned towing vehicle.

15. The vehicle hitch aligning system according to claim 1, wherein said stop plate is removable from the hitch receiver.

16. The vehicle hitch aligning system according to claim 1, wherein said stop plate is adapted for being fixedly attached and braced to a ball mount of the hitch receiver.

17. A vehicle hitch aligning system for aligning a tow hitch ball mount attached to a towing vehicle with a coupler attached to a trailer tongue, comprising:
means for aligning the ball mount in axial alignment with the coupler; and
means for aligning the coupler in vertical alignment above a ball attached to the ball mount.
